(19) United States
(12) Patent Application Publication
(10) Pub. No.: US 2014/0333482 A1
(43) Pub. Date: Nov. 13, 2014

(54) METHODS OF POSITION-LOCATION DETERMINATION USING A HIGH-CONFIDENCE RANGE, AND RELATED SYSTEMS AND DEVICES

(71) Applicant: Telcom Ventures, LLC, Miami, FL (US)

(72) Inventors: Rajendra Singh, Indian Creek Village, FL (US); George Ron Olexa, Gainesville, GA (US)

(73) Assignee: Telcom Ventures, LLC, Miami, FL (US)

(21) Appl. No.: 14/273,004

(22) Filed: May 8, 2014

Related U.S. Application Data
(60) Provisional application No. 61/821,871, filed on May 10, 2013.

(51) Int. Cl. G01S 5/10

(52) U.S. Cl. CPC G01S 5/10
USPC 342/463

(57) ABSTRACT

Methods of position-location determination are provided. The methods may include determining a first range for a wireless user device, using signaling from a high-confidence first ranging source. The methods may include determining a second range for the wireless user device, using signaling from a second ranging source that corresponds to a lower confidence than the high-confidence first ranging source. Moreover, the methods may include determining a position-location of the wireless user device by using a first geometric shape that is defined based on the first range. Related wireless user devices and central systems and/or central devices are also described.

### CLAIM OF PRIORITY

The present application claims the benefit of U.S. Provisional Patent Application Ser. No. 61/821,871, filed May 10, 2013, entitled Methods of Position-Location Determination Using a High-Confidence Range Calculation, the disclosure of which is hereby incorporated herein in its entirety by reference.

### FIELD

The present disclosure relates to wireless communications methods, systems, and devices and, more particularly, to methods, systems, and devices that determine position location.

### BACKGROUND

Examples of Position Location Systems (PLSs) include Global Positioning System (GPS), Wi-Fi, assisted GPS (e.g., using cell towers), and/or Terrestrial Beacon Network (TBN) systems. These systems may provide varying degrees of accuracy for position-location determination. For example, GPS may be highly accurate under open-sky conditions, but may not be very usable in urban canyons or inside buildings. Similarly, a Long Term Evolution (LTE) based position can provide a very good fix for a serving cell, but may not be very accurate for ranging from neighboring cells. Moreover, a TBN may have ranging errors from multiple beacons, where there may be very high confidence (e.g., accurate range determination) from one of the beacons based on Signal-to-Noise Ratio (SNR), pulse shape of a correlation peak, and/or based on some a priori determination, but less confidence from a set of other beacons.

### SUMMARY

According to some embodiments, methods of position-location determination are provided. The methods may include determining a first range for a wireless user device, using signaling from a high-confidence first ranging source. The methods may include determining a second range for the wireless user device, using signaling from a second ranging source that corresponds to a lower confidence than the high-confidence first ranging source (and the second range may thus correspond to a lower confidence than the first range). The methods may include determining whether first and second geometric shapes that are defined based on the first and second ranges, respectively, intersect. The methods may include determining a third range for the wireless user device, using signaling from a third ranging source. Moreover, the methods may include determining a position-location of the wireless user device by using the third range to indicate a position along a perimeter of the first geometric shape. Wireless user devices, central devices, and/or central systems, configured to perform the methods, may also be provided.

In some embodiments, the methods may include adjusting the second range in response to determining that the first and second geometric shapes do not intersect. In some embodiments, the methods may include estimating the position-location of the wireless user device before adjusting the second range, and determining the position-location of the wireless user device may include using an adjustment to (e.g., a projection of) the second range to indicate a position on the perimeter of the first geometric shape. Moreover, adjusting the second range may include projecting the second range onto the first geometric shape that is defined based on the first range of the high-confidence first ranging source, in response to determining that the first and second geometric shapes do not intersect. The first and second geometric shapes may include first and second circles, respectively, that do not intersect, and projecting the second range may include increasing or decreasing a radius of the second circle such that a perimeter of the second circle is on the perimeter of the first circle. Moreover, the first range may indicate a distance between the first ranging source and the wireless user device, and the first range may defines a radius of the first circle.

In some embodiments, determining the position-location of the wireless user device may include determining the position-location of the wireless user device by using the third range to indicate the position along the perimeter of the first geometric shape, after determining whether the first and second geometric shapes intersect. Moreover, the third ranging source may correspond to a higher confidence and/or a higher accuracy than the second ranging source (and the third range may thus correspond to a higher confidence and/or a higher accuracy than the second range).

In some embodiments, the first and second ranging sources may belong to (i.e., be a part of) different position location systems, respectively. The different position location systems both be the same type of position location system (e.g., may be the same one of Global Positioning System (GPS), Wi-Fi, cellular, or Terrestrial Beacon Network (TBN)). Alternatively, the different position location systems may be different types of position location systems (e.g., may be different ones among Global Positioning System (GPS), Wi-Fi, cellular, and Terrestrial Beacon Network (TBN)).

In some embodiments, the first, second, and third ranging sources may belong to (e.g., be a part of) a same position location system. In some embodiments, the first and second ranges may be first and second range calculations, respectively, and the first range calculation may be more accurate than the second range calculation. Moreover, determining the first range may include selecting the high-confidence first ranging source for use (by the wireless user device or a central system/device, of the first range) in determining the position-location of the wireless user device, based on at least one of a received signal parameter, position-location-system type, ranging-source elevation, ranging-source proximity to the wireless user device, most-limited-range ranging source, history of providing highest-precision range calculations, and ranging-source bandwidth. The received signal parameter may include at least one of received signal strength, signal-to-noise ratio, and a shape of a correlation peak.

In some embodiments, determining the first range may include determining that the high-confidence first ranging source is a highest-confidence and/or highest-accuracy ranging source among a plurality of ranging sources, and may include selecting the high-confidence first ranging source for use (by the wireless user device or a central system/device, of the first range) in determining the position-location of the wireless user device, in response to determining that the high-confidence first ranging source is the highest-confidence and/or highest-accuracy ranging source among the plurality of ranging sources. Additionally or alternatively, selecting the high-confidence first ranging source may include selecting a ranging source exceeding a threshold level of signal quality.

According to some embodiments, methods of position-location determination are provided. The methods may include determining, using a wireless user device, a high-confidence first range calculation for the wireless user device, using signaling from a high-confidence first ranging source. The methods may include determining, using the wireless user device, a second range calculation for the wireless user device, using signaling from a second ranging source that corresponds to a lower confidence than the high-confidence first ranging source. The first and second range calculations may define first and second radii of first and second circles, respectively. The methods may include projecting, using the wireless user device, the second range calculation onto the first circle by increasing or decreasing the second radius such that an end point of the second radius is on a perimeter of the first circle. Moreover, the methods may include determining a position-location of the wireless user device by using the end point of the second radius on the perimeter of the first circle. Wireless user devices configured to perform the methods, may also be provided.

In some embodiments, the methods may include determining, using the wireless user device, whether the first and second circles corresponding to the first and second range calculations, respectively, intersect. Moreover, projecting the second range calculation may include projecting the second range calculation onto the first circle by increasing or decreasing the second radius such that the end point of the second radius is on the perimeter of the first circle, in response to determining that the first and second circles corresponding to the first and second range calculations, respectively, do not intersect.

In some embodiments, the methods may include determining, using the wireless user device, a third range calculation for the wireless user device, using signaling from a third ranging source. Moreover, determining the position-location of the wireless user device may include using the third range calculation to indicate a position along the perimeter of the first circle.

According to some embodiments, wireless user devices are provided. The wireless user devices may include a processor configured to determine a high-confidence first range calculation for the wireless user device, using signaling from a high-confidence first ranging source. The processor may be configured to determine a second range calculation for the wireless user device, using signaling from a second ranging source that corresponds to a lower confidence than the high-confidence first ranging source. The first and second range calculations may define first and second radii of first and second circles, respectively. The processor may be configured to project the second range calculation onto the first circle by increasing or decreasing the second radius such that an end point of the second radius is on a perimeter of the first circle. Moreover, the processor may be configured to determine a position-location of the wireless user device by using the end point of the second radius on the perimeter of the first circle.

In some embodiments, the processor may be configured to determine whether the first and second circles corresponding to the first and second range calculations, respectively, intersect. Moreover, the processor may be configured to project the second range calculation onto the first circle by increasing or decreasing the second radius such that the end point of the second radius is on the perimeter of the first circle, in response to determining that the first and second circles corresponding to the first and second range calculations, respectively, do not intersect.

In some embodiments, the processor may be configured to determine a third range calculation for the wireless user device, using signaling from a third ranging source. Moreover, the processor may be configured to determine the position-location of the wireless user device by using the third range calculation to indicate a position along the perimeter of the first circle.

### BRIEF DESCRIPTION OF THE DRAWINGS

FIGS. 1A-3C are schematic diagrams illustrating a geographical area that includes a wireless electronic user device and transmitters/ranging sources, according to various embodiments described herein.

FIGS. 4A-4C illustrate circles defined by ranges corresponding to different ranging sources, according to various embodiments described herein.

FIG. 5 is a flowchart illustrating operations for position-location determination, using a high-confidence range, according to various embodiments described herein.

FIG. 6 is a block diagram of a wireless electronic user device, according to various embodiments described herein.

### DETAILED DESCRIPTION

Example embodiments of the present inventive concepts now will be described with reference to the accompanying drawings. The present inventive concepts may, however, be embodied in a variety of different forms and should not be construed as limited to the embodiments set forth herein. Rather, these embodiments are provided so that this disclosure will be thorough and complete, and will fully convey the scope of the present inventive concepts to those skilled in the art. In the drawings, like designations refer to like elements. It will be understood that when an element is referred to as being “connected,” “coupled,” or “responsive” to another element, it can be directly connected, coupled, or responsive to the other element or intervening elements may be present. Furthermore, “connected,” “coupled,” or “responsive” as used herein may include wirelessly connected, coupled, or responsive.

The terminology used herein is for the purpose of describing particular embodiments of the present inventive concepts only and is not intended to be limiting of the present inventive concepts. As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. The symbol “/” is also used as a shorthand notation for “and/or.”

Unless otherwise defined, all terms (including technical and scientific terms) used herein have the same meaning as commonly understood by one of ordinary skill in the art to which the present inventive concepts belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that although the terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of the present inventive concepts.

The present inventive concepts are described in part below with reference to a flowchart of operations and devices/systems according to embodiments of the present inventive concepts. A given block or blocks of the flowchart provides support for operations and/or devices/systems.

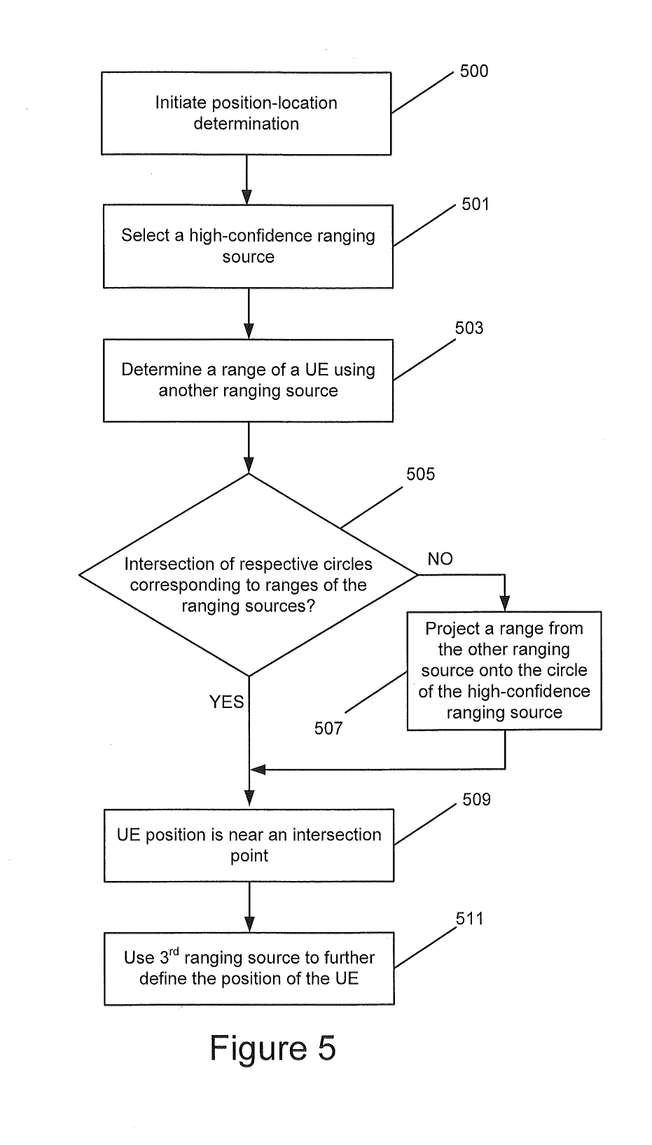

Also, in some implementations, the functions/acts noted in the flowchart may occur out of the order noted in the flowchart. For example, two blocks shown in succession may in fact be executed substantially concurrently or the blocks may sometimes be executed in the reverse order, depending upon the functionality/acts involved. As an example, the operations of Block 511 of FIG. 5 may occur before the operations of Blocks 503-507 of FIG. 5. Finally, the functionality of one or more blocks may be separated and/or combined with that of other blocks. For example, the operations of Blocks 505 and 507 may be repeated to project a range of the third ranging source of Block 511 onto the circle of the high-confidence ranging source.

Different PLSs may have different degrees of confidence in ranging error. For example, a fully-synchronized LTE network may have a high degree of confidence in a range determination of a serving cell, but may not have any ranging determinations of neighboring cells due to low SNRs. Having only one range determination, however, may not be sufficient to determine the location of a User Equipment (UE). Rather, three or more range determinations from known locations may be required to determine the location of the UE. Although these different PLSs may have different confidence levels (or even the same PLS may have different sources (such as beacons or cell towers) with different confidence levels), various embodiments of the present inventive concepts use a high-confidence range calculation and, in some cases, geometric projection (e.g., projection of a lower confidence/accuracy range calculation onto a geometric shape derived from the high-confidence range calculation), to reduce errors in determining position location.

For example, operations described herein may include combining an individual highly-accurate range calculation (or two highly-accurate range calculations) with range calculations in which less confidence is present. These range calculations can belong to a single PLS or may belong to different PLSs (e.g., different ones of GPS, TBN, cell towers, and Wi-Fi). An advantage of using a high-confidence range calculation and, in some cases, geometric projection, is to reduce position-location determination error without experiencing a heavy processing burden.

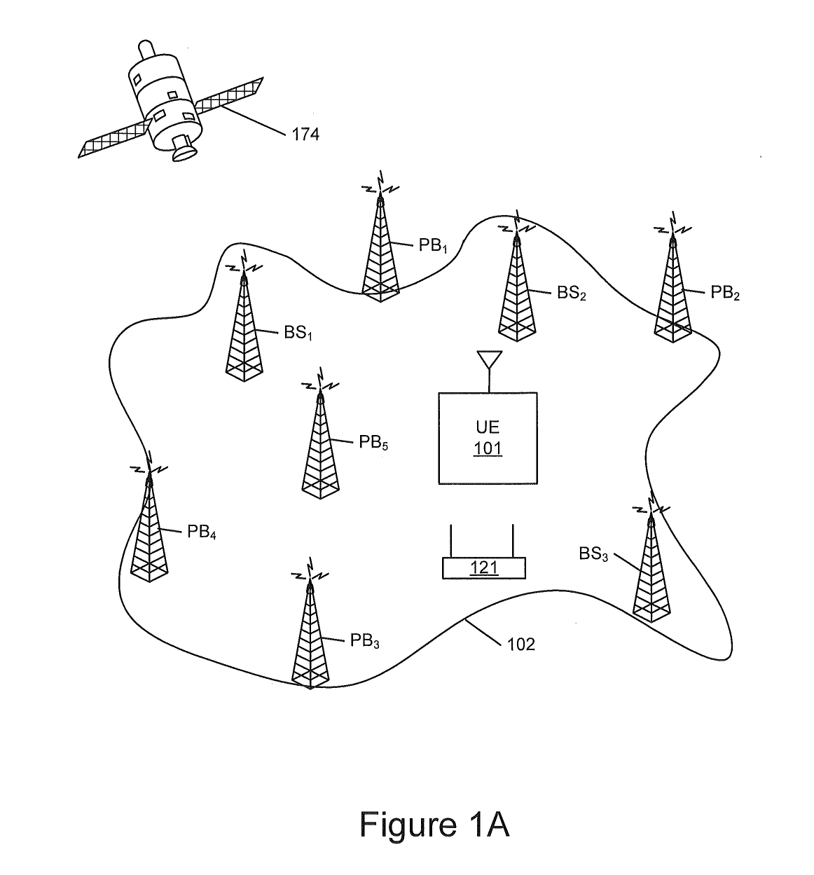

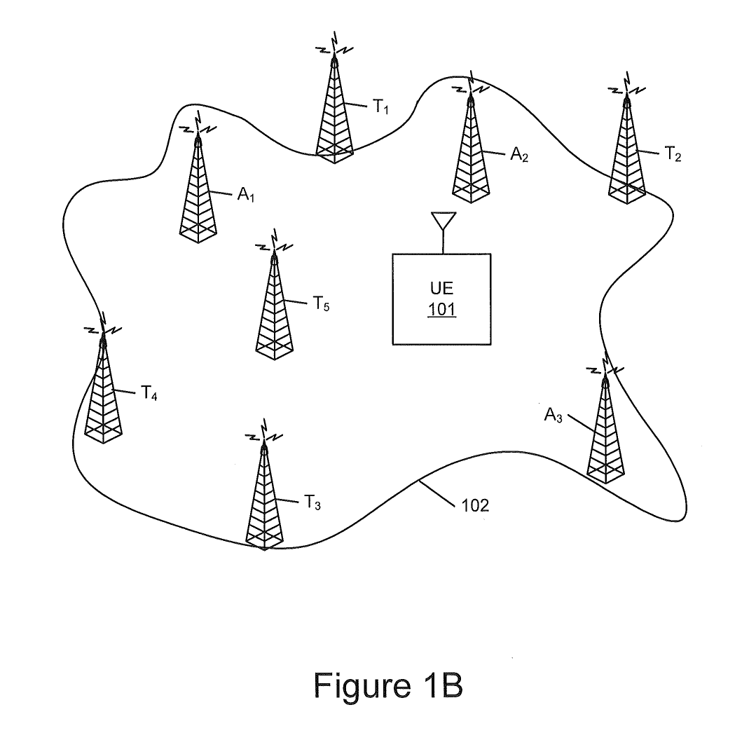

Referring now to FIG. 1A, a UE 101 is illustrated in a geographical area 102. The UE 101 may be (or may be a part of) one of various types of wireless electronic user devices (including mobile/cell phones, as well as wireless electronic user devices without phone capabilities). The UE 101 can be located anywhere inside the geographical area 102. Although FIG. 1A illustrates a single UE 101, a plurality of UEs 101 may be located inside the geographical area 102. In some embodiments, hundreds, thousands, or more UEs 101 may be located inside the geographical area 102.

The UE 101 may wirelessly receive signals from transmitters such as a Base Station (BS)(e.g., a cellular BS) and/or from a Positioning Beacon (PB) of a Terrestrial Beacon Network (TBN). It will be understood that the geographical area 102 may include any number of (e.g., three, four, dozens, or more) BSs and/or PBs. Moreover, the UE 101 may receive signals from a Wi-Fi hot spot 121 in the geographical area 102 and/or from a GPS network 174. Accordingly, the location (e.g., position) of the UE 101 may be determined using signals to/from the BSs, PBs, the Wi-Fi hot spot 121, and/or the GPS network 174.

Referring now to FIG. 1B, ranging sources T₁-T₅ belong to PLS system T, and ranging sources A₁-A₃ belong to PLS system A. Specifically, two PLSs T and A are illustrated in FIG. 1B as a non-limiting example. PLSs T and A can belong to the same PLS type (such as a TBN) or they may belong to two different types of PLSs (such as GPS and TBN; TBN and LTE; TBN and Wi-Fi; or any other combination of different types of PLSs). As an example, the ranging sources A₁-A₃ of PLS system A may be the BS₁-BS₃, respectively, of FIG. 1A, which may be LTE base stations. Similarly, the ranging sources T₁-T₅ of PLS system T may be the PB₁-PB₅, respectively, of FIG. 1A. Moreover, the combination may include more than two types of PLS systems, in some embodiments of the present inventive concepts.

According to some embodiments of the present inventive concepts, the position of the UE 101 in FIG. 1B may initially be determined/estimated without/before using geometric projection (e.g., projection of a lower confidence/accuracy range calculation onto a geometric shape derived from a high-confidence range calculation). Based on this initial calculation, range calculations from a set of ranging sources (e.g., a set including ranging sources T₂, T₃, T₅, A₂, and A₃) may be selected. Moreover, the range calculations described herein may refer to distances calculated using signals to and/or from the ranging sources, which distances may be calculated by the ranging sources or by the UE 101.

Referring now to FIG. 5, a flowchart of position-location determination operations is illustrated. The position-location determination operations are initiated in Block 500, and may be performed by the UE 101 and/or at a central system/location (e.g., a central device/receiver that is spaced apart from the UE 101) that receives signal data regarding a set of ranging sources.

Referring still to FIG. 5, based on, for example, Signal-to-Noise Ratio (SNR), shape of a correlation peak, and/or some prior measurement(s) of the geographical area 102 where the UE 101 is generally located, a high or highest confidence/accuracy ranging source (and thus a range calculation with low/least error) may be selected (Block 501). A high confidence/accuracy ranging source may be the highest confidence/accuracy ranging source among a set of ranging sources in communications range with the UE 101, and/or may be any ranging source that exceeds a threshold level of signal quality measurement(s).

For example, operations of Block 501 may include determining that a ranging source is the highest confidence/accuracy ranging source among a plurality of ranging sources. Moreover, the operations may include selecting the ranging source as a high-confidence ranging source for use in determining the position-location of the UE 101, in response to determining that the ranging source is the highest confidence/accuracy ranging source among the plurality of ranging sources (and/or in response to determining that the ranging source exceeds a threshold level of signal quality). As an example, the ranging source A₂ may be an LTE (or other cellular) serving cell with a very high SNR. Accordingly, a high degree (e.g., level) of confidence may be present with respect to the range calculation of the ranging source A₂, which range calculation may be based on a direct signal path and not significantly affected by a multipath projection of radio signals. In particular, a high-confidence ranging source, as described herein, refers to a ranging source for which a high degree/level of confidence is present with respect to the accuracy of the range calculation of the ranging source.

The same confidence determination may be made for a beacon from a TBN, based on real-time calculations or based on prior measurements of the geographical area 102. Moreover, if a determination of confidence in ranging errors from the set (T₂, T₃, T₅, A₂, and A₃) of ranging sources in the example in FIG. 1B can be established based on received signal parameters, then the initial calculation described above regarding the position of the UE 101 can be skipped. Additionally or alternatively, in some embodiments, more than one high confidence/accuracy ranging source may be selected.

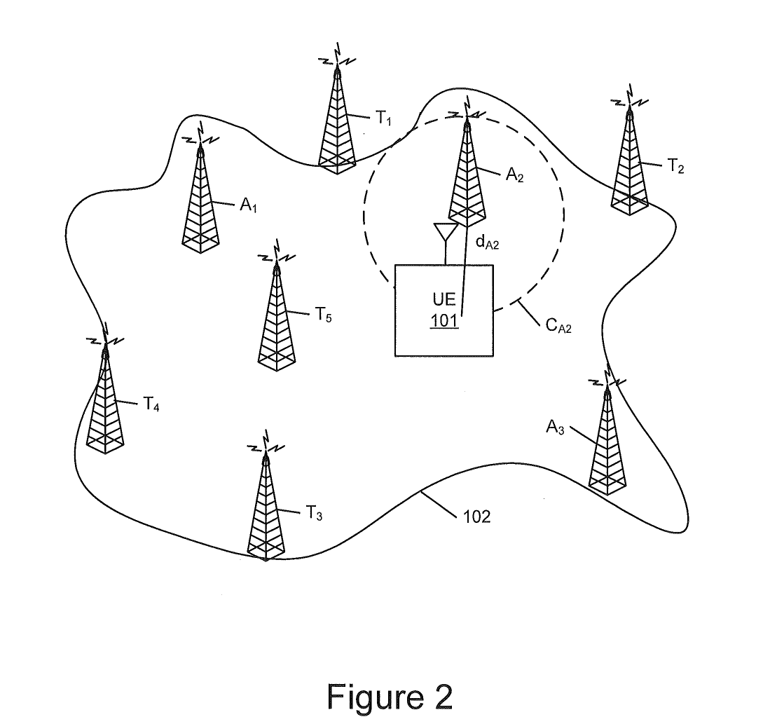

In the example in FIG. 1B, the ranging source A₂ may be the best candidate for providing the reference range (i.e., the most accurate range calculation, with the least error in the range). For example, this range may be a calculated distance referred to as a range d_{A2}, as illustrated in FIG. 2. A high degree of confidence corresponds to the calculated range d_{A2}, and it may thus be assumed that the calculated range d_{A2} from the ranging source A₂ to the UE 101 is very close to the actual distance (especially when compared to other range calculations in the set). Accordingly, as the ranging source A₂ is a high-confidence ranging source, it may be determined that the UE 101 is located somewhere on the perimeter of a circle C_{A2} around A₂ at the distance d_{A2}, as illustrated in FIG. 2.

Moreover, various metrics can be used to determine that a ranging source is a high-confidence ranging source. For example, such a determination may be based on a priori knowledge regarding the type of PLS that includes a given ranging source, as some PLSs, such as TBNs, may be more finely tuned for position-location determinations, whereas a general-purpose wireless communications system, such as an LTE system, may be tuned primarily for data and secondarily for position-location determinations. In another example, a determination that a ranging source is a high-confidence ranging source may be based on identifying that the ranging source is located at a relatively high-elevation site, which may help to provide a good SNR, because such a high-elevation ranging source may be likely to have more of a direct signal path (rather than multipath conditions) with the UE 101. In yet another example, a determination that a ranging source is a high-confidence ranging source may be based on real-time signal parameters such as received signal strength or SNR. In a further example, such a determination can be based on a pulse shape of a correlation peak, which may itself be based on a history of received signals over time.

In some embodiments, a determination that a ranging source is a high-confidence ranging source may be based on a combination of two or more of the above-described metrics, where different metrics may be weighted differently (i.e., given different respective weights) in the determination. Alternatively, in the absence or substantial equality of additional performance metrics, such a determination may be based on identifying that the ranging source has the shortest range (i.e., is the closest ranging source to the UE 101), as the closest ranging source may be the most accurate ranging source.

In another example in which additional performance metrics may be absent or substantially equal, the determination may be based on identifying that the ranging source is the ranging source with the most limited range, because such a ranging source may indicate a very limited area in which a range can be determined. The Wi-Fi hot spot 121, for example, despite general inaccuracies with respect to position-location determination, may only communicate with the UE 101 when the UE 101 is in a small area near the Wi-Fi hot spot 121.

In a further example in which additional performance metrics may be absent or substantially equal, the determination may be based on identifying that the ranging source has a history of providing the highest-precision range calculations among a set of available ranging sources. Moreover, as a wide bandwidth ranging source may be more likely to resolve multipath conditions and may therefore be more likely to provide a high-accuracy range calculation, if other metrics (e.g., signal strength, SNR, ranging source elevation/location, and/or prior data about the approximate location of the UE 101) are absent or substantially equal, then the wide bandwidth ranging source (e.g., the ranging source providing the widest bandwidth signal(s)) may be identified as a high-confidence ranging source. Accordingly, one or more of the above-described metrics may be used to select a high-confidence ranging source at Block 501 of FIG. 5.

Referring still to FIG. 5, an additional range may be determined using another ranging source (Block 503). In particular, the other ranging source may be a lower confidence/accuracy ranging source than the high-confidence ranging source. For example, a range d_{T3} for the UE 101 from the site of the ranging source T₃ may be calculated, and the ranging source T₃ may be a lower confidence/accuracy ranging source than the high-confidence ranging source A₂. In some cases, the lower confidence/accuracy ranging source T₃ may have a confidence/accuracy below a threshold level. Moreover, in some embodiments, the lower confidence/accuracy ranging source T₃ and the high-confidence ranging source A₂ may be ranging sources in different types of PLSs.

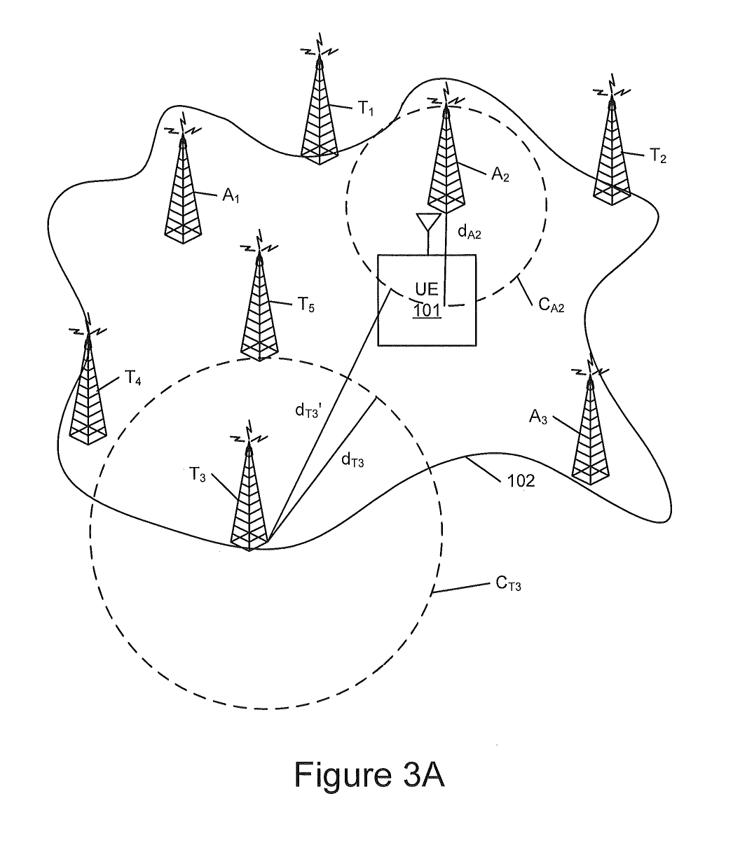

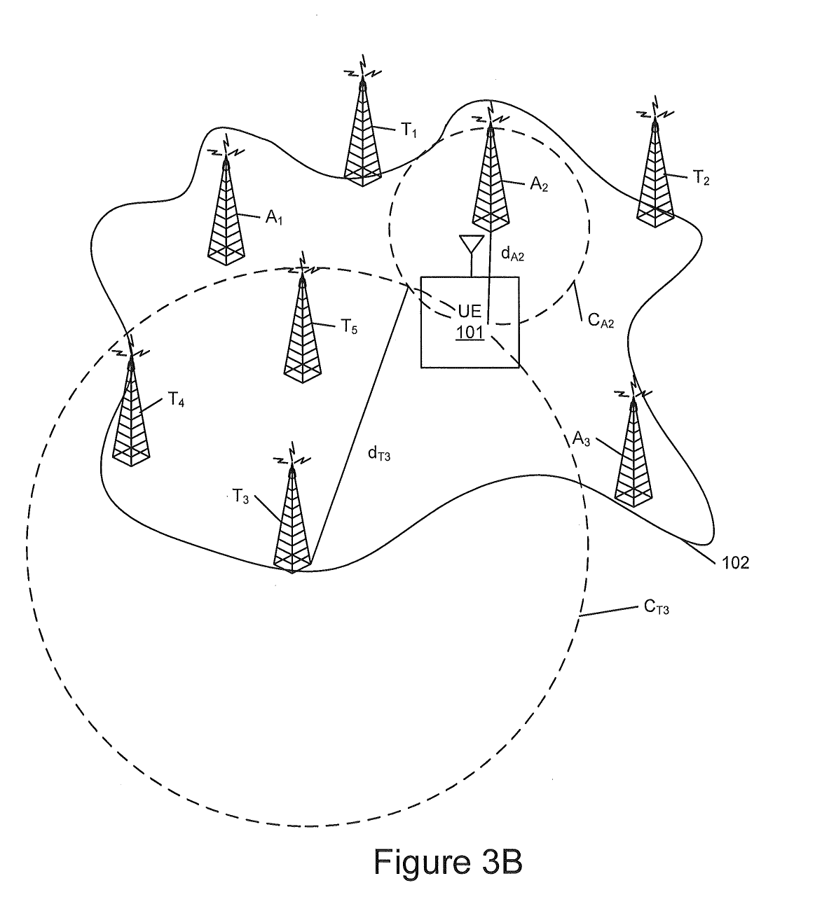

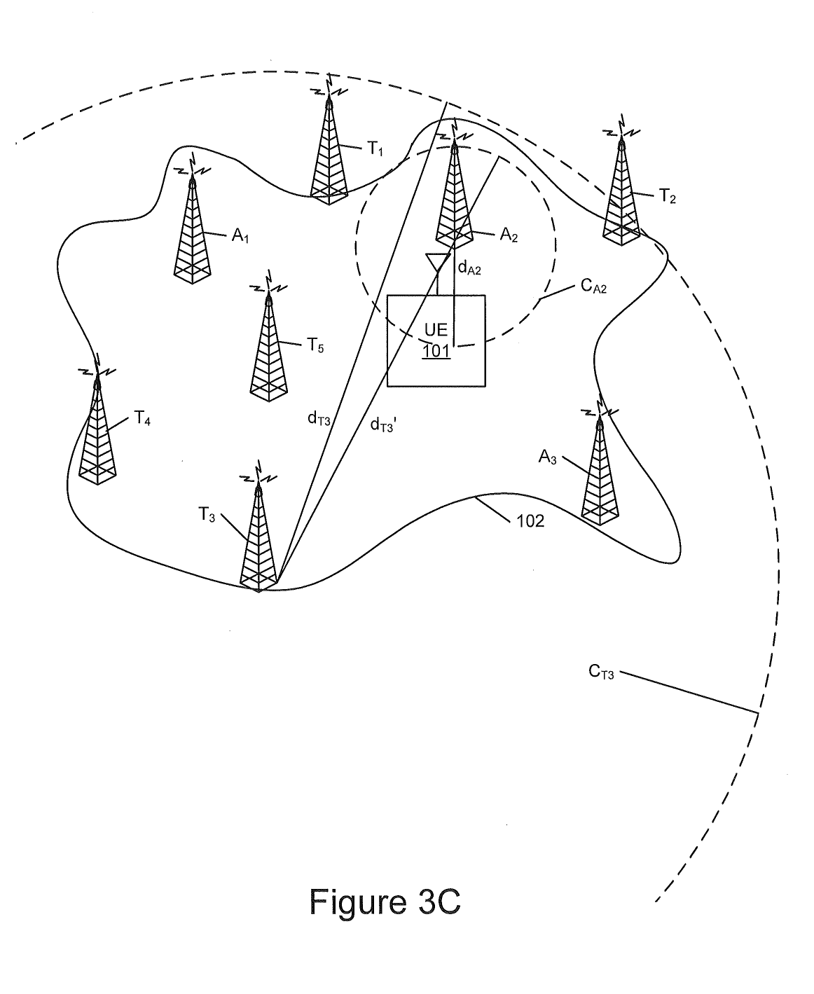

Referring now to FIGS. 3A-3C, as well as FIG. 5, based on the location of the ranging sources A₂ and T₃ (which may both be known), two circles C_{A2} (with radius d_{A2} around A₂) and C_{T3} (with radius d_{T3} around T₃) may either intersect or not intersect (Block 505). If the two circles C_{A2} and C_{T3} intersect, as illustrated in FIG. 3B, then no geometric projection/adjustment may be necessary for the calculated range d_{T3} of the ranging source T₃. If, on the other hand, the two circles C_{A2} and C_{T3} do not intersect (as illustrated in FIGS. 3A and 3C), then the range d_{T3} of the ranging source T₃ may be projected onto the more accurate circle C_{A2} (having the range/radius d_{A2}) such that the two circles C_{A2} and C_{T3} may just slightly touch each other (Block 507 of FIG. 5). For example, the range d_{T3} may be projected from the ranging source T₃ to a closest (i.e., as defined by the shortest distance between the circle C_{T3} and the circle C_{A2}) point of the circle C_{A2} of the high-confidence ranging source A₂. Accordingly, the calculated range d_{T3} from the ranging source T₃ may be adjusted to d_{T3}′ using geometric projection, as illustrated in FIGS. 3A and 3C. Moreover, such geometric projection operations can additionally or alternatively be performed for the other ranges (e.g., ranges corresponding to ranging sources T₂, T₅, and A₃) in the set.

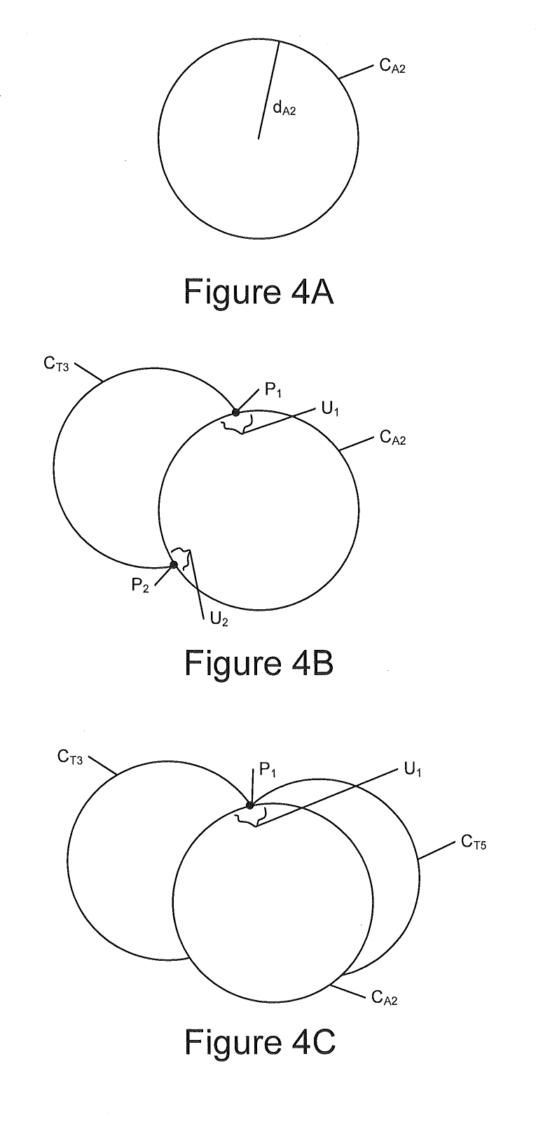

Referring now to FIGS. 4A-4C, if one high confidence/reliability (i.e., known high accuracy) range/radius is available, then a perimeter of a circle defined by this range/radius may identify all possible locations of the UE 101. For example, as the ranging source A₂ is a high-confidence ranging source in the examples of FIGS. 2-4C, it may be determined that the UE 101 is located somewhere on the perimeter of the circle C_{A2} around the ranging source A₂ at the distance d_{A2}. Moreover, referring to FIGS. 4B and 5, as the circles C_{A2} and C_{T3} intersect at points P₁ and P₂, it may be determined that the UE 101 is located either near point P₁ or near point P₂ on the perimeter of the circle C (Block 509).

In other words, additional ranges from other ranging source sites may intersect the perimeter of the high-accuracy range circle C_{A2}. For example, the intersection points P₁ and P₂ in FIG. 4B indicate two possible approximate locations of the UE 101. In particular, the locations are approximate because the accuracy/reliability of the lower accuracy/confidence range circle C_{T3} may result in uncertainty ranges U₁ and U₂ corresponding to the intersection points P₁ and P₂. The uncertainty ranges U₁ and U₂ may be defined by the sizes of the circles C_{A2} and C_{T3}, as well as by a maximum uncertainty associated with the lower accuracy/confidence range circle C_{T3}, and the magnitudes of U₁ and U₂ may be equal. Each of the uncertainty ranges U₁ and U₂ may be bounded by points on the perimeter of the high-accuracy range circle C_{A2}.

FIGS. 4A-4C illustrate a simplified view of the two intersecting circles C_{A2} and C_{T3} corresponding to the ranges d_{A2} and d_{T3} of the ranging sources A₂ and T₃, respectively, illustrated in FIG. 3B. Moreover, a range projected onto the high-accuracy range circle C_{A2} in Block 507 of FIG. 5 may provide a single intersection point of the circle C_{A2} and the projected range d_{T3}′, and such an intersection point may have a corresponding uncertainty range. Accordingly, referring to FIGS. 3A and 3C and Blocks 507 and 509 of FIG. 5, it may be determined that the UE 101 is located near the intersection point of the circle C_{A2} and the projected range d_{T3}′.

Referring to FIGS. 4C and 5, a third ranging source may be used to further define/refine the position location of the UE 101 along the perimeter of the high-accuracy range circle C_{A2} (Block 511). For example, referring to FIG. 4C, after a third range is available, the third range may (a) eliminate one of the two points P₁ and P₂/uncertainty ranges U₁ and U₂ and/or (b) provide another boundary reference to limit the remaining uncertainty range U₁. In particular, FIG. 4C illustrates that the circle C_{T5} corresponding to a range of the ranging source T₅ may intersect the high-accuracy range circle C_{A2} at the point P₁ and thus eliminate the point P₂ as a possible location near which the UE 101 may be positioned. Moreover, by intersecting the high-accuracy range circle C_{A2}, the circle C_{T5} may provide another boundary reference to limit the remaining uncertainty range U₁. Furthermore, the intersection of the two lower accuracy/confidence circles C_{T3} and C_{T5} may be used to bound the uncertainty range U₁ to a smaller segment of the perimeter of the high-accuracy range circle C_{A2}. Additional ranges (i.e., fourth, fifth, or more ranges) may further isolate and bound the uncertainty range U₁ to a smaller segment of the perimeter of the high-accuracy range circle C_{A2}.

Accordingly, by combining one or more lower accuracy/confidence-level ranges with a high accuracy/confidence-level trusted reference range, and, in some cases, by using geometric projection, various embodiments of the present inventive concepts may reduce position-location determination error without adding a substantial processing burden on a communications system. Moreover, the high accuracy/confidence-level trusted reference range and the one or more lower accuracy/confidence-level ranges may respectively correspond to ranging sources in different PLSs (and/or correspond to different types of PLSs).

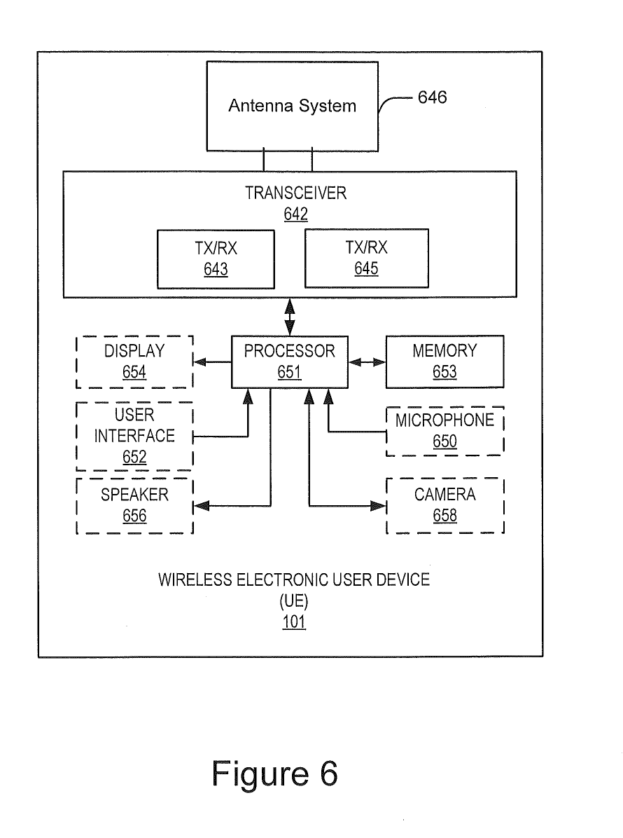

Also, FIG. 6 is a block diagram of a wireless electronic user device (or UE) 101 according to some embodiments. As illustrated in FIG. 6, a wireless electronic user device 101 may include an antenna system 646, a transceiver 642, a processor (e.g., processor circuit) 651, and a memory 653. Moreover, the wireless electronic user device 101 may optionally include a display 654, a user interface 652, a speaker 656, a camera 658, and/or a microphone 650.

A transmitter portion of the transceiver 642 may convert information, which is to be transmitted by the wireless electronic user device 101, into electromagnetic signals suitable for radio communications. A receiver portion of the transceiver 642 may demodulate electromagnetic signals, which are received by the wireless electronic user device 101 (e.g., from one of the transmitters/ranging sources illustrated in FIGS. 1A-3C). The transceiver 642 may include transmit/receive circuitry (TX/RX) that provides separate communication paths for supplying/receiving RF signals to different radiating elements of the antenna system 646 via their respective RF feeds. Accordingly, when the antenna system 646 includes two active antenna elements, the transceiver 642 may include two transmit/receive circuits 643, 645 connected to different ones of the antenna elements via the respective RF feeds.

Referring still to FIG. 6, the memory 653 can store computer program instructions that, when executed by the processor circuit 651, carry out operations of the wireless electronic user device 101 (e.g., as illustrated in the flow chart of FIG. 5). As an example, the memory 653 can be non-volatile memory, such as a flash memory, that retains the stored data while power is removed from the memory 653.

A variety of different embodiments of the present inventive concepts have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments of the present inventive concepts described herein, and of the manner and process of making and using them, and shall support claims to any such combination or subcombination.

In the drawings and specification, there have been disclosed example embodiments of the present inventive concepts. Although specific terms are employed, they are used in a generic and descriptive sense only and not for purposes of limitation, the scope of the present inventive concepts being defined by the following claims.

What is claimed is:

1. A method of position-location determination, the method comprising:
determining a first range for a wireless user device, using signaling from a high-confidence first ranging source;
determining a second range for the wireless user device, using signaling from a second ranging source that corresponds to a lower confidence than the high-confidence first ranging source;
determining whether first and second geometric shapes that are defined based on the first and second ranges, respectively, intersect;
determining a third range for the wireless user device, using signaling from a third ranging source; and
determining a position-location of the wireless user device by using the third range to indicate a position along a perimeter of the first geometric shape.

2. The method of claim 1, further comprising:
adjusting the second range in response to determining that the first and second geometric shapes do not intersect.

3. The method of claim 2, wherein adjusting the second range comprises:
projecting the second range onto the first geometric shape that is defined based on the first range of the high-confidence first ranging source, in response to determining that the first and second geometric shapes do not intersect.

4. The method of claim 3,
wherein the first and second geometric shapes comprise first and second circles, respectively, that do not intersect, and
wherein projecting the second range comprises increasing or decreasing a radius of the second circle such that a perimeter of the second circle is on the perimeter of the first circle.

5. The method of claim 4,
wherein the first range indicates a distance between the first ranging source and the wireless user device, and
wherein the first range defines a radius of the first circle.

6. The method of claim 2, further comprising estimating the position-location of the wireless user device before adjusting the second range, wherein determining the position-location of the wireless user device further comprises using an adjustment to the second range to indicate a position on the perimeter of the first geometric shape.

7. The method of claim 1, wherein determining the position-location of the wireless user device comprises:
determining the position-location of the wireless user device by using the third range to indicate the position along the perimeter of the first geometric shape, after determining whether the first and second geometric shapes intersect.

8. The method of claim 7, wherein the third ranging source corresponds to a higher confidence and/or a higher accuracy than the second ranging source.

9. The method of claim 1, wherein the first and second ranging sources belong to different position location systems, respectively.

10. The method of claim 9,
wherein the different position location systems comprise a same type of position location system, and
wherein the same type comprises one of Global Positioning System (GPS), Wi-Fi, cellular, or Terrestrial Beacon Network (TBN).

11. The method of claim 9,
wherein the different position location systems comprise different types of position location systems, and
wherein the different types comprises different ones among Global Positioning System (GPS), Wi-Fi, cellular, and Terrestrial Beacon Network (TBN).

12. The method of claim 1, wherein the first, second, and third ranging sources belong to a same position location system.

13. The method of claim 1,
wherein the first and second ranges comprise first and second range calculations, respectively, and
wherein the first range calculation is more accurate than the second range calculation.

14. The method of claim 1, wherein determining the first range comprises selecting the high-confidence first ranging source for use in determining the position-location of the wireless user device, based on at least one of:
a received signal parameter;
position-location-system type;
ranging-source elevation;
ranging-source proximity to the wireless user device;
most-limited-range ranging source;
history of providing highest-precision range calculations; and
ranging-source bandwidth.

15. The method of claim 14, wherein the received signal parameter comprises at least one of:
received signal strength;
signal-to-noise ratio; and
a shape of a correlation peak.

16. The method of claim 1, wherein determining the first range comprises:
determining that the high-confidence first ranging source comprises a highest-confidence and/or highest-accuracy ranging source among a plurality of ranging sources; and
selecting the high-confidence first ranging source for use in determining the position-location of the wireless user device, in response to determining that the high-confidence first ranging source comprises the highest-confidence and/or highest-accuracy ranging source among the plurality of ranging sources.

17. The method of claim 1, wherein determining the first range comprises:
determining that the high-confidence first ranging source exceeds a threshold level of signal quality; and
selecting the high-confidence first ranging source for use in determining the position-location of the wireless user device, in response to determining that the high-confidence first ranging source exceeds the threshold level of signal quality.

18. The wireless user device, configured to perform the method of claim 1.

19. A central system or central device that receives signal data regarding a plurality of ranging sources, the central system or central device configured to perform the method of claim 1.

20. A method of position-location determination, the method comprising:
determining, using a wireless user device, a high-confidence first range calculation for the wireless user device, using signaling from a high-confidence first ranging source;
determining, using the wireless user device, a second range calculation for the wireless user device, using signaling from a second ranging source that corresponds to a lower confidence than the high-confidence first ranging source, wherein the first and second range calculations define first and second radii of first and second circles, respectively;
projecting, using the wireless user device, the second range calculation onto the first circle by increasing or decreasing the second radius such that an end point of the second radius is on a perimeter of the first circle; and
determining a position-location of the wireless user device by using the end point of the second radius on the perimeter of the first circle.

21. The method of claim 20, further comprising:
determining, using the wireless user device, whether the first and second circles corresponding to the first and second range calculations, respectively, intersect,
wherein projecting the second range calculation comprises projecting the second range calculation onto the first circle by increasing or decreasing the second radius such that the end point of the second radius is on the perimeter of the first circle, in response to determining that the first and second circles corresponding to the first and second range calculations, respectively, do not intersect.

22. The method of claim 20, further comprising:
determining, using the wireless user device, a third range calculation for the wireless user device, using signaling from a third ranging source,
wherein determining the position-location of the wireless user device further comprises:
using the third range calculation to indicate a position along the perimeter of the first circle.

23. The wireless user device, configured to perform the method of claim 20.

24. A wireless user device, comprising:
a processor configured to:
determine a high-confidence first range calculation for the wireless user device, using signaling from a high-confidence first ranging source;
determine a second range calculation for the wireless user device, using signaling from a second ranging source that corresponds to a lower confidence than the high-confidence first ranging source, wherein the first and second range calculations define first and second radii of first and second circles, respectively;
project the second range calculation onto the first circle by increasing or decreasing the second radius such that an end point of the second radius is on a perimeter of the first circle; and
determine a position-location of the wireless user device by using the end point of the second radius on the perimeter of the first circle.

25. The wireless user device of claim 24, wherein the processor is further configured to:
determine whether the first and second circles corresponding to the first and second range calculations, respectively, intersect; and
project the second range calculation onto the first circle by increasing or decreasing the second radius such that the end point of the second radius is on the perimeter of the first circle, in response to determining that the first and second circles corresponding to the first and second range calculations, respectively, do not intersect.

26. The wireless user device of claim 24, wherein the processor is further configured to:
determine a third range calculation for the wireless user device, using signaling from a third ranging source; and
determine the position-location of the wireless user device by using the third range calculation to indicate a position along the perimeter of the first circle.
